(19) United States
(12) Patent Application Publication
(10) Pub. No.: US 2001/0024026 A1
(43) Pub. Date: Sep. 27, 2001

(54) ADJUSTABLE BOAT TRAILER

(76) Inventor: GEORGE KNUTSSON, PINELLAS COUNTY, FL (US)

Correspondence Address: ARTHUR W FISHER, SUITE 316, 5553 WEST WATERS AVENUE, TAMPA, FL, 33634

(21) Appl. No.: 09/237,279

(22) Filed: Jan. 26, 1999

(51) Int. Cl. B60P 3/10; B62D 63/08

(52) U.S. Cl. 280/414.1

(57) ABSTRACT

A boat trailer with an adjustable winch station selectively moveable along the longitudinal axis of the boat trailer and adjustable boat hull support bunks selectively moveable along the lateral axis of the boat trailer to accommodate boats of varying height, length and width, the adjustable winch station is mounted on a quick-release adjustable winch station positioning assembly disposed on a longitudinal member of the boat trailer frame and the adjustable boat hull support bunks are mounted on quick-release adjustable bunk positioning assemblies disposed on lateral members of the boat trailer frame.

### CROSS REFERENCE

This is a continuation-in-part application of pending application Ser. No. 08/710679, filed Sep. 23, 1996.

### BACKGROUND OF THE INVENTION

1. Field of the Invention

A adjustable boat trailer to accommodate boats of varying height, length and width with an adjustable winch station mounted on a hand-operable quick-release adjustable winch station positioning assembly selectively positioned along the longitudinal axis of the boat trailer without the use of tools or other implements and adjustable boat hull support bunks mounted on hand-operable quick-release adjustable bunk positioning assemblies selectively positioned along the lateral axis of the boat trailer without the use of tools or other implements.

2. Description of the Prior Art

Many small recreational and commercial boats are stored in wet slips, on davits, or in public boat storage facilities rather than on trailers. Periodically, the owners of craft stored in this fashion have need of trailers to transport these craft over land. Although there are many trailers available which can be purchased and customer fitted to a particular boat, there is a need for a trailer which can be easily adjusted thereby facilitating the rental rather than purchase of a boat trailer for periodic or isolated use.

U.S. Pat. No. 4,717,165 describes a boat trailer having the parallel boat supporting portions of the trailer frame free of any fixed cross frame members rigidly connected to the trailer side booms. The parallel spacing between this portion of the trailer frame is effected by a downwardly curved cross bar member pivotally connected at each end to the trailer side frames. The ends of the pivotally connected cross bar are supported from the trailer side frames in a manner which eliminates the necessity of any side frame-to-cross bar mounting bracketry.

U.S. Pat. No. 4,329,108 teaches an adjustable length boat trailer with a movable tongue including an elongated shaft portion slideably and releasably secured to the frame of the trailer.

U.S. Pat. No. 5,518,261 shows a boat trailer with arcuate elements extending longitudinally from the frame of the trailer and supporting winch units at the ends thereof.

U.S. Pat. No. 5,172,928 discloses a boat trailer with a bow stop unit which can be moved along the frame thereof and secured in a desired position thereon.

U.S. Pat. No. 5,417,447 teaches a boat trailer including a winch mounting assembly including a winch post adjustably mounted on the tongue of the trailer.

Additional examples of the prior art are found in U.S. Pat. No. 2,779,602; U.S. Pat. No. 3,029,960; U.S. Pat. No. 3,044,646; U.S. Pat. No. 3,185,330; U.S. Pat. No. 3,578,190; U.S. Pat. No. 4,592,694; and U.S. Pat. No. 5,161,814.

### SUMMARY OF THE INVENTION

The present invention relates to a boat trailer with an adjustable winch station selectively moveable along the longitudinal axis of the boat trailer and adjustable boat hull support bunks selectively moveable along the lateral axis of the boat trailer to accommodate boats of varying height, length and width. The adjustable winch station being mounted on a quick-release adjustable winch station positioning assembly comprising a guide means telescopingly disposed on longitudinal member of the boat trailer frame and an integral-hand operated stop means to engage said longitudinal member to retain said quick-release positioning assembly in a selected position thereon without the use of tools or other implements and the adjustable boat hull support bunks being mounted on a quick-release adjustable bunk positing assemblies comprising a guide means telescopingly disposed on a lateral member of the boat trailer frame and an integral hand operated stop means to engage said lateral member to retain said quick-release positioning assembly in a selected position thereon without the use of tools or other implements.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a plan view of the boat trailer of the present invention.

FIG. 2 is a side view of the boat trailer of the present invention.

FIG. 3 is a detailed side view of the adjustable winch station of the present invention with the adjustable winch station disposed midway along the length of the longitudinally disposed member.

FIG. 4 is a detailed cross-sectional end view taken along line 4-4 of FIG. 3 with the retaining elements of the quick-release adjustable winch station assembly in the first position.

FIG. 5 is a detailed cross-sectional end view taken along line 5-5 of FIG. 2 with the retaining elements of the adjustable boat hull support bunks in the first position.

FIG. 6 is a side view of the boat trailer of the present invent on with the adjustable winch assembly in an elevated position and the adjustable winch station in a full forward position relative to the trailer accommodating a boat of maximum size.

FIG. 7 is a side view of the boat trailer of the present invention 18 with the winch assembly in an lowered position and the adjustable winch station in an intermediate position along the longitudinal member relative to the trailer and accommodating a boat of smaller size.

FIG. 8 is a detailed side view of the boat trailer of the present invention depicting the adjustable winch station.

FIG. 9 is a plan view of the boat trailer of the present invention depicting the adjustable winch station and adjustable boat hull support bunks. Similar reference characters refer to similar parts throughout the several views of the drawings.

### DETAILED DESCRIPTION OF THE PREFERRED EMBODIMENT

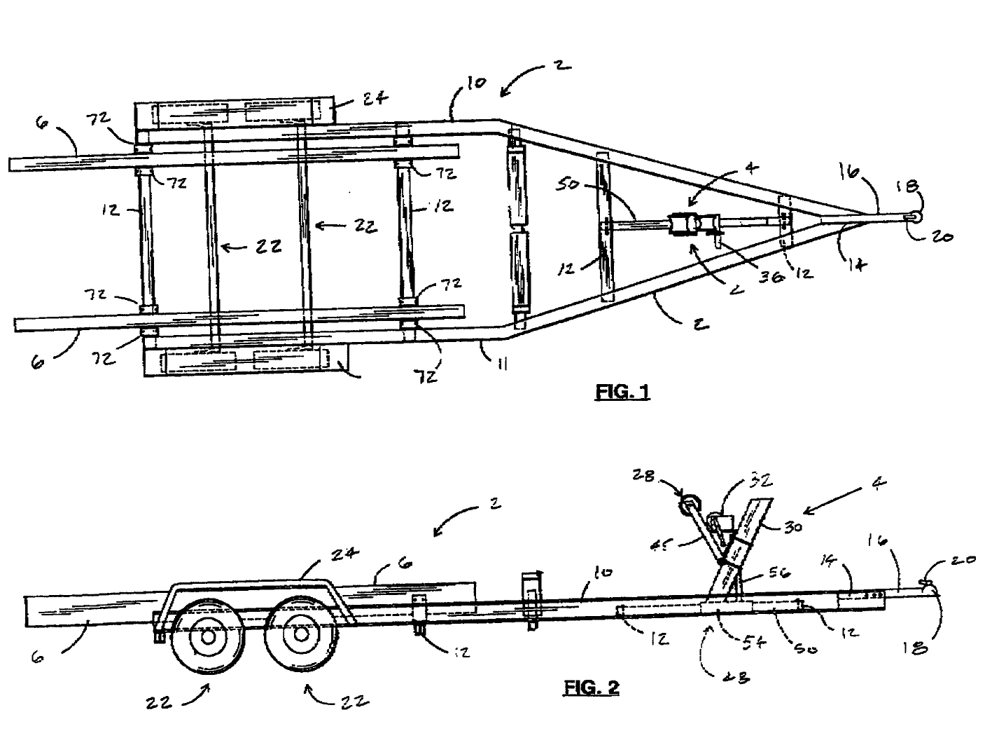

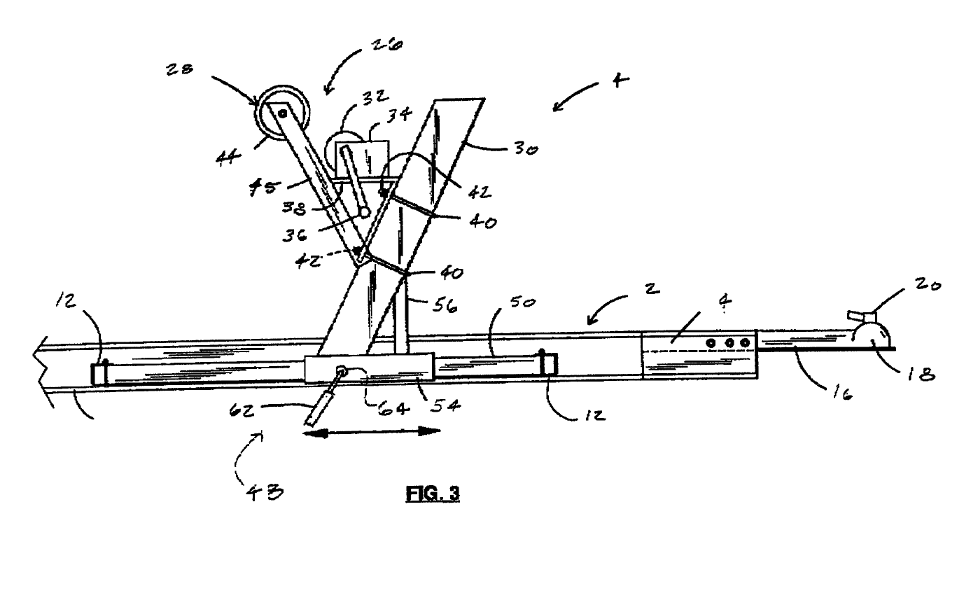

As best shown in FIGS. 1 and 2, the present invention relates to a boat trailer generally indicated as 2 with an adjustable winch station 4 selectively moveable along the longitudinal axis of the boat trailer and adjustable boat hull support bunks 6 selectively moveable along the lateral axis of the boat trailer 10. The boat trailer 2 comprises a frame 8 with two lateral members 10 and 11 extending substantially the length thereof and being connected to one another by two or more transverse members each indicated as 12. The two lateral members 10 and 11 converge at the forward portion of the boat trailer 2 terminating at an intermediate longitudinal member 14. An additional lateral member 16 extends outward from the intermediate lateral member 14 with a socket 18 formed at the end thereof to receive the ball of a trailer hitch mounted on a motor vehicle (not shown). A clasp mechanism 20 integral with the socket 18 selectively retains the trailer hitch ball (not shown) within the socket 18 while the boat trailer 10 is towed behind a motor vehicle. At least one axle and wheel assembly generally indicated as 22 including fenders 34 to prevent water and dirt thrown from the tires from striking the boat of the boat is mounted between the lateral frame members 10 and 11.

As best shown in FIG. 3, the adjustable winch station 4 comprises a winch assembly 26 and bow cradle 28 movably attached to a stanchion 30. The winch assembly 26 comprises a cable spool 32 rotatively disposed within a spool frame 34 and selectively operated by a hand crank 36. The winch assembly 26 is mounted on a sub-frame 38 which is movably attached to the stanchion 30 by a connecting means comprising one or more retaining elements 40 such as threaded rods surrounding the stanchion 30 and penetrating the sub-frame 38 at each end and held in place by bolts 42. The bow cradle 28 comprises a pliable disc 44 including a concave outer edge to engage the vertical edge 46 of the bow of the boat 46. The pliable disc 44 is mounted on a substantially vertical member 45 formed on one edge of the sub-frame 46.

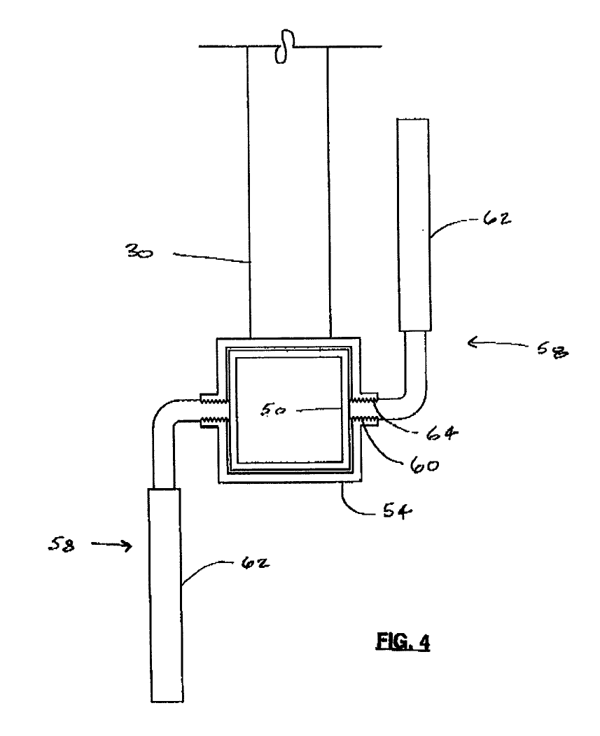

As best shown in FIGS. 3 and 4, the adjustable winch station 4 is mounted on a quick-release adjustable winch station positioning assembly 48 movably disposed on a longitudinal member 50 of the trailer frame 8. The quick-release adjustable winch station positioning assembly 50 includes a guide means 52 comprising a sleeve 54 formed in the lower end of the stanchion 30 to receive longitudinal member 50. Both the sleeve 54 and the longitudinal frame member 50 are of rectilinear cross section such that the sleeve 54 is prevented from rotating around the longitudinal axis of the longitudinal member 50. A brace 56 may be added between the stanchion 30 and sleeve 54 to reinforced the connection therebetween.

As best shown in FIG. 4, one or more one quick release retaining elements generally indicated as 58 is disposed on the sleeve 54 and comprises a threaded member 60 formed on the end of handle 62. The threaded member 60 is received by a threaded opening 64 in the sleeve 54. In order to secure the adjustable winch station 4 in a fixed position relative to the longitudinal frame member 50, the handle 62 is rotated from a first position to a second position in which the interaction of threaded member 60 and threaded opening 64 draws the threaded member 60 inward through the threaded opening 64 and into contact with the longitudinal member 50. The resulting friction created by the contact between the threaded member 60 and longitudinal member 50 prevent movement of sleeve 54 relative to the longitudinal member 50.

To selectively move the adjustable winch station 4 relative to the longitudinal member 50, the handle 62 is rotated from the second position to the first position in which the interaction of threaded member 60 and threaded opening 64 draws the threaded member 60 outward through the threaded opening 64 and out of contact with the longitudinal member 50. The longitudinal member 50 and sleeve 54 are of size and shape relative to each other that the sleeve 54 will move freely along the length of the longitudinal member 50 in the absence of contact between the threaded member 60 and longitudinal member 50.

As shown in FIGS. 1, 2, 5 and 9, the adjustable boat hull support bunks 6 are mounted on quick-release adjustable boat support bunk positioning assemblies 66 movably disposed on a transverse member 12 of the trailer frame 8. Similar to the quick-release adjustable winch station positioning assembly 48, each quick-release adjustable boat support bunk positioning assembly 66 includes a guide means 68 comprising a sleeve 70 formed in the lower end of the boat support bunk support mounting member 72 to receive transverse member 12. Both the sleeve 70 and the transverse member 12 are of rectilinear cross section such that the sleeve 70 is prevented from rotating around the longitudinal axis of the transverse member 12. Sleeve 70 is of sufficient length to resist binding between sleeve 70 and transverse member 12 bending moment is applied to the quick release adjustable boat support positioning assembly 66 during the positioning of the adjustable boat hull support bunks 6. At least one quick-release retaining element generally indicated as 74 is disposed on the sleeve 70 and comprises a threaded member 76 formed on the end of handle 78. The threaded member 76 is received by a threaded opening 80 in the sleeve 70. In order to secure the adjustable winch station 4 in a fixed position relative to the transverse member 12, the handle 78 is rotated from a first position to a second position in which the interaction of threaded member 76 and threaded opening 80 draws the threaded member 76 inward through the threaded opening 80 and into contact with the transverse member 12. The resulting friction created by the contact between the threaded member 76 and transverse member 12 prevent movement of sleeve 70 relative to the transverse member 12.

To selectively move the adjustable boat hull support bunks 6 relative to the transverse member 12, the handle 78 is rotated from the second position to the first position in which the interaction of threaded member 76 and threaded opening 80 draws the threaded member 76 outward through the threaded opening 80 and out of contact with the transverse member 12. The transverse member 12 and sleeve 70 are of size and shape relative to each other that the sleeve 70 will move freely along the length of the transverse member 12 in the absence of contact between the threaded member 76 and transverse member 12.

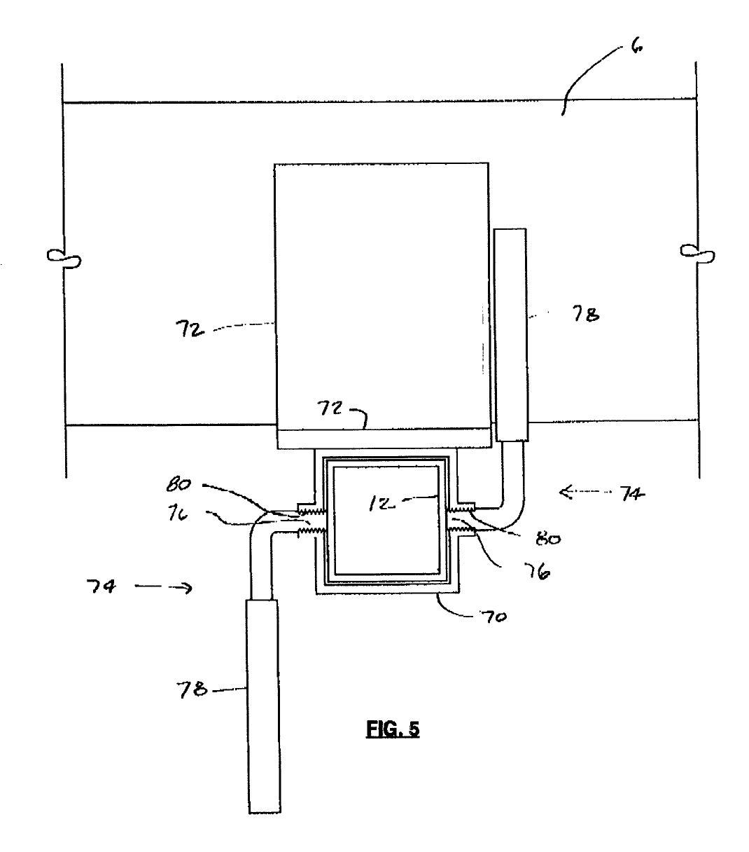

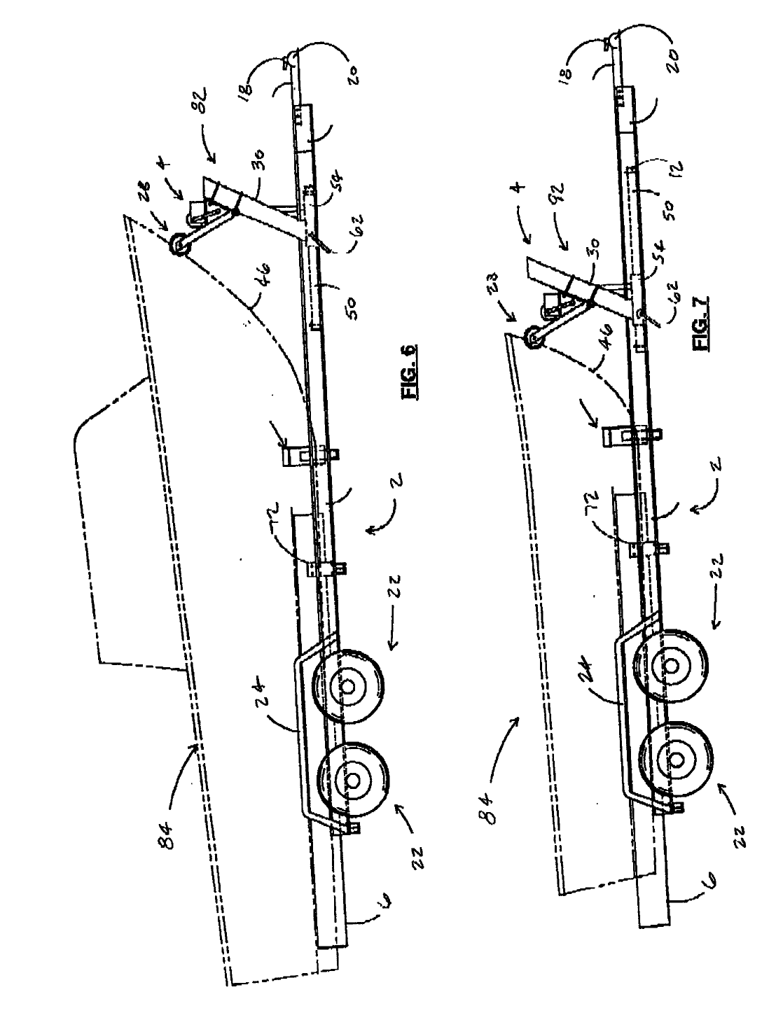

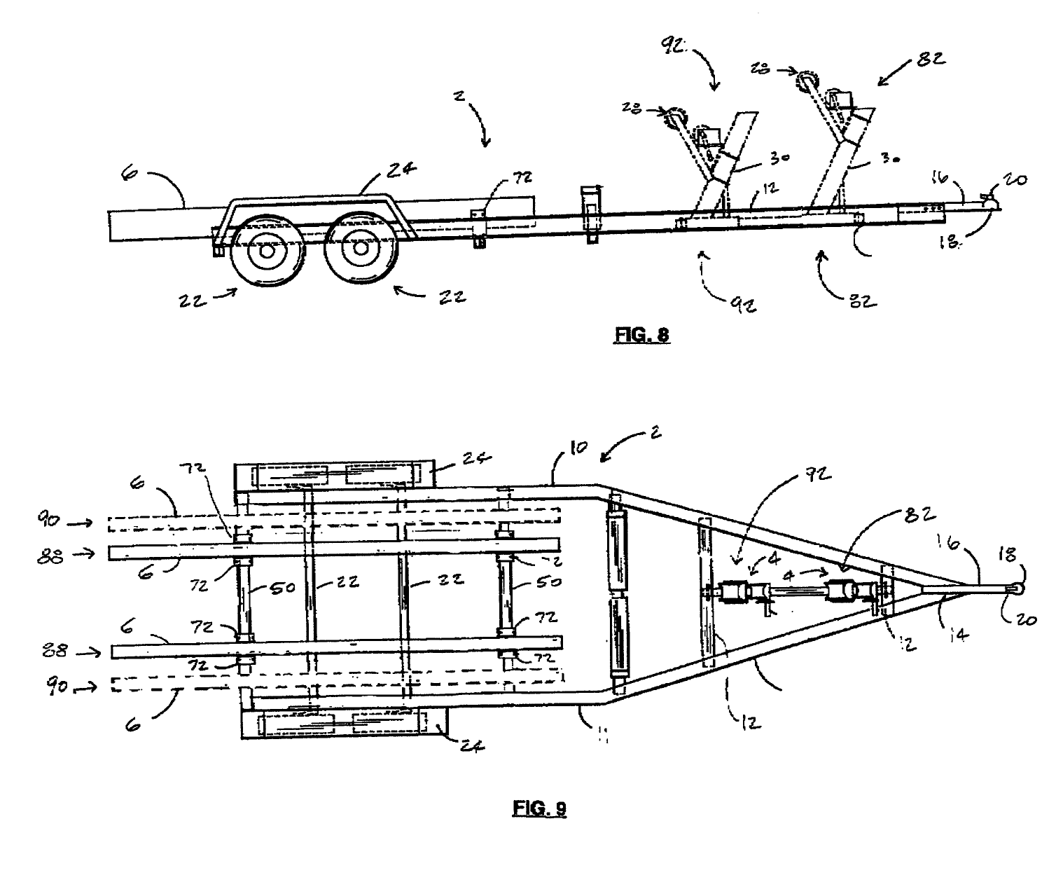

Selective use of the present invention with boats of varying size is best understood with reference to FIGS. 1 and 5 through 7. As shown in FIG. 5, to accommodate a boat of relatively greater length, the adjustable winch station 4 is moved to a forward position 82 along the longitudinal member 50 relative to the boat trailer 2 in order to provide for a boat 84 of relatively higher center of gravity or greater bow height, the winch assembly 26 is moved to an elevated position 86 on the stanchion 30. Similarly, to accommodate a boat 56 of relatively greater width, the adjustable boat hull support bunks 6 are moved from an inward position 88 to an outward position 90 along transverse members 12 relative to the boat trailer 2.

As shown in FIG. 6, to accommodate boats of smaller size, the adjustable winch station 4 is moved to a rearward position 92 along the longitudinal member 50 relative to the boat trailer 2. in order to provide for a boat of relatively lower center of gravity or lesser bow height, the adjustable winch assembly 4 is moved to an lowered position 94 on the stanchion 30. Similarly, with reference to FIG. 1, the adjustable boats support bunks 6 are moved from an outward position 90 to an inward 88 position.

As constructed, since the longitudinally disposed support member 50 is disposed within the lateral members 10 and 11 of the frame, the adjustable winch station 4 may adjust to accommodate boats 56 from 17 feet to 24 feet or 25 feet to 33 feet. This provides an increase in the virtual length of the boat trailer 2 of at least a thirty (30%) percent.

It will be seen that the objects set forth above, among those made apparent from the preceding description are efficiently attained and since certain changes may be made in the above description without departing from the scope of the invention, it is intended that all matter contained within the above description or shown in the accompanying drawings shall be interpreted as illustrative and not in a limiting sense.

It is also to be understood that the following claims are intended to cover all of the general and specific features of the invention herein described, and all statements of the scope of the invention which, as a matter of language, might be said to fall therebetween.

Now that the invention has been described,

what is claimed is:

1. A boat trailer selectively adjustable to accommodate boats of varying size including an adjustable winch station selectively moveable along the longitudinal axis of the boat trailer and adjustable boat hull support bunks selectively moveable along the lateral axis of the boat trailer to accommodate boats of varying height, length and width, the adjustable winch station being mounted on a quick-release adjustable winch station positioning assembly comprising a guide means telescopingly disposed on longitudinal member of the boat trailer frame and an integral hand-operated stop means selectively between a first position whereby the adjustable winch station may be moved freely along the length of the longitudinal member and second position whereby said adjustable winch station is retained in a fixed position on the longitudinal member and the adjustable boat hull support bunks are mounted on a quick-release bunk positioning assemblies comprising a guide means telescopingly disposed on a lateral member of the boat trailer frame and an integral hand-operated stop means selectively movable between a first position whereby the adjustable boat hull support bunks may be moved freely along the length of the lateral member and a second position whereby said adjustable boat hull support bunks are retained in a fixed position on the lateral member.

2. The boat trailer of claim 1 where said sleeve and longitudinal member are of rectilinear cross-section.

3. The boat trailer of claim 2 where said integral hand-operated stop means comprises a threaded member disposed within a threaded opening in said sleeve.

4. The boat trailer of claim 3 where said integral hand-operated stop means includes a integral handle whereby the integral had-operated stop means may be selectively moved between the first position and the second position without the use of tools or other implements.

5. The boat trailer of claim 4 where said sleeve is of sufficient length to resists binding on said longitudinal or lateral member when bending moment is exerted on said quick-release adjustable winch station positioning assembly or quick-release adjustable boat hull support bunk positioning assembly.
